(19) United States
(12) Patent Application Publication
(10) Pub. No.: US 2009/0104515 A1
(43) Pub. Date: Apr. 23, 2009

(54) LITHIUM SECONDARY BATTERY

(76) Inventors: Masato Fujikawa, Osaka (JP); Hideharu Takezawa, Nara (JP); Miyuki Nakai, Osaka (JP)

Correspondence Address: MCDERMOTT WILL & EMERY LLP, 600 13TH STREET, NW, WASHINGTON, DC, 20005-3096, US

(21) Appl. No.: 12/255,963

(22) Filed: Oct. 22, 2008

(30) Foreign Application Priority Data
Oct. 23, 2007 (JP) 2007-275419

(51) Int. Cl. H01M 10/36; H01M 2/14

(52) U.S. Cl. 429/129

(57) ABSTRACT

A lithium secondary battery of this invention includes: a positive electrode including a positive electrode active material; a negative electrode including a negative electrode active material; a separator; and a non-aqueous electrolyte. The negative electrode active material includes a first portion capable of absorbing and desorbing lithium ions and a second portion covering at least a part of a surface of the first portion. The second portion includes at least one material that is less reactive with oxygen than the first portion.

### FIELD OF THE INVENTION

The invention relates to lithium secondary batteries, and mainly to an improvement of a negative electrode included in a lithium secondary battery.

### BACKGROUND OF THE INVENTION

Lithium secondary batteries have high capacity and high energy density, and their size and weight can be easily reduced. They are thus widely used as the power source for portable small-size electronic devices, such as cellular phones, personal digital assistants (PDAs), notebook personal computers, video cameras, and portable game machines. A typical lithium secondary battery is composed of a positive electrode including a lithium cobalt compound as a positive electrode active material, a negative electrode including a carbon material as a negative electrode active material, and a separator made of a polyolefin porous film. Such lithium secondary batteries have high capacity, high power, and long life. However, portable small-size electronic devices are required to provide more functions and thus longer continuous operation time. To meet such requirements, lithium secondary batteries are also required to provide higher capacity.

In order to further heighten the capacity of lithium secondary batteries, for example, high capacity negative electrode active materials are being developed. As high capacity negative electrode active materials, alloy-type negative electrode active materials that absorb lithium by alloying with lithium are receiving attention. Known alloy-type negative electrode active materials are silicon containing materials such as silicon (simple substance), silicon oxides, silicon nitrides, and silicon containing alloys. These alloy-type negative electrode active materials have high discharge capacities. For example, the theoretical discharge capacity of silicon is approximately 4199 mAh/g, which is approximately 11 times higher than the theoretical discharge capacity of graphite, which has been conventionally used as a negative electrode active material.

Such alloy-type negative electrode active materials are effective for heightening the capacity of lithium secondary batteries. However, in order to put lithium secondary batteries including alloy-type negative electrode active materials into practical use, there are some problems to be solved. For example, when such a silicon containing material absorbs lithium, its crystal structure changes and its volume increases. A large change in the volume of an active material due to charge/discharge causes, for example, a poor contact between the active material and the current collector, thereby resulting in shortened charge/discharge cycle life.

Various proposals have been made to improve the cycle characteristics of lithium secondary batteries including alloy-type negative electrode active materials. For example, Japanese Laid-Open Patent Publication No. 2006-59714 (Document 1) proposes a negative electrode including a tin containing layer and a first layer. The tin containing layer contains a second layer therein, and the first layer is disposed between the tin containing layer and the negative electrode current collector. The first layer and the second layer include an element that expands at a rate different from tin when alloying with lithium. Document 1 cites, for example, Si, as such an element.

However, the negative electrode active material layer used in Document 1 is in the form of a film. When a film-shaped active material layer repeatedly expands and contracts due to charge/discharge, the active material layer may become cracked, warped or the like, since the expansion stress cannot be sufficiently eased. Thus, the active material layer may become pulverized, losing its shape. In this case, the conductivity of the negative electrode active material layer lowers and the cycle characteristics degrade. In Examples of Document 1, only the capacity retention rate at the 15^{th} cycle is measured, and there are some Examples in which the capacity retention rate at the 15^{th} cycle is as low as approximately 60%.

Meanwhile, silicon containing materials such as silicon (simple substance) are highly susceptible to oxidation. In particular, in a high temperature atmosphere, such a silicon containing material is rapidly oxidized by oxygen resulting from, for example, decomposition of a positive electrode active material. Further, the oxidation of the silicon containing material involves generation of a large amount of heat, which may further promote the decomposition of the positive electrode active material. Hence, the battery temperature may sharply rise.

It is therefore an object of the invention to provide a lithium secondary battery whose safety is further improved by suppressing the generation of heat due to the reaction between the negative electrode active material capable of absorbing and desorbing lithium ions and oxygen.

### BRIEF SUMMARY OF THE INVENTION

The lithium secondary battery of the invention includes: a positive electrode including a positive electrode active material; a negative electrode including a negative electrode active material; a separator; and a non-aqueous electrolyte. The negative electrode active material includes a first portion capable of absorbing and desorbing lithium ions and a second portion covering at least a part of a surface of the first portion. The second portion includes at least one material that is less reactive with oxygen than the first portion.

The second portion preferably includes at least one material selected from the group consisting of metallic tin, metallic nickel, metallic cobalt, carbon simple substance, a silicon oxide A, and a tin oxide. The silicon oxide A is preferably represented by SiOₓ where 1.0≦x≦2. The tin oxide is preferably represented by SnO_{z} where 1.0≦z≦2. More preferably, the second portion includes a metallic tin layer.

In a preferable embodiment of the invention, the second portion includes a first layer containing metallic tin and at least one second layer selected from the group consisting of a metallic nickel layer and a metallic cobalt layer, and the second layer is carried on the first layer.

The second portion preferably covers 50% or more of the surface of the first portion. The second portion preferably has a thickness of 0.1 to 5 μm.

The first portion preferably includes a Si containing material. The Si containing material preferably includes at least one material selected from the group consisting of silicon simple substance, a silicon oxide B, a silicon nitride, a silicon containing alloy, and a silicon containing compound. The silicon oxide B is preferably represented by SiO_{y} where 0≦y≦0.8.

The positive electrode active material preferably includes an olivine-type lithium phosphate.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a longitudinal sectional view schematically showing a lithium secondary battery according to one embodiment of the invention;

FIG. 2 is a schematic view showing an exemplary deposition device that can be used to form a first portion;

FIG. 3 is a sectional view schematically showing a negative electrode included in a lithium secondary battery according to another embodiment of the invention;

FIG. 4 is a longitudinal sectional view schematically showing an active material particle included in a negative electrode of a lithium secondary battery according to still another embodiment of the invention;

FIG. 5 is a longitudinal sectional view schematically showing an active material particle included in a negative electrode of a lithium secondary battery according to still another embodiment of the invention;

FIG. 6 is a schematic view showing an exemplary deposition device that can be used to produce the active material particle illustrated in FIG. 4 or FIG. 5; and

FIG. 7 is a sectional view schematically showing a negative electrode included in a lithium secondary battery according to still another embodiment of the invention.

### DETAILED DESCRIPTION OF THE INVENTION

The lithium secondary battery of the invention includes: a positive electrode including a positive electrode active material; a negative electrode including a negative electrode active material; a separator interposed between the positive electrode and the negative electrode; and a non-aqueous electrolyte. The negative electrode active material comprises a first portion capable of absorbing and desorbing lithium ions and a second portion covering at least a part of a surface of the first portion. The second portion includes at least one material that is less reactive with oxygen than the first portion.

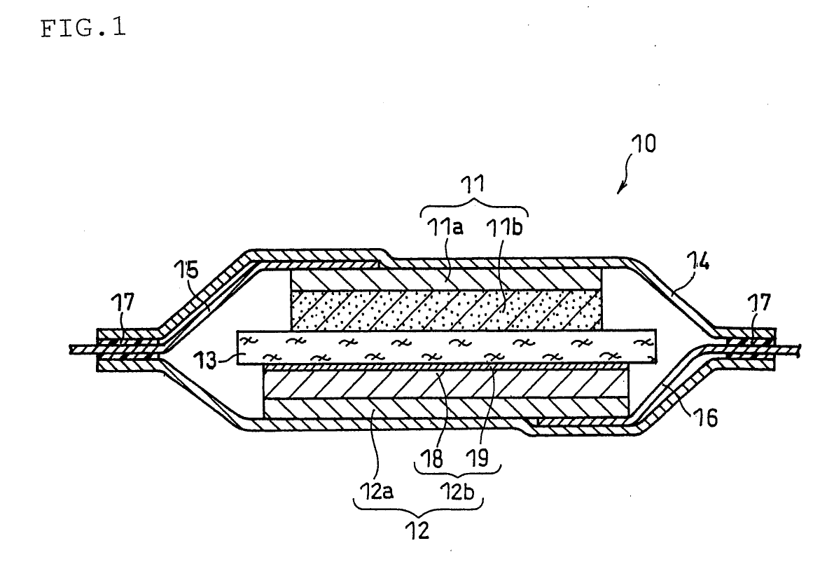

FIG. 1 is a longitudinal sectional view of a lithium secondary battery according to one embodiment of the invention. A battery 10 of FIG. 1 includes a layered-type electrode assembly and a non-aqueous electrolyte (not shown) contained in a battery case 14. The electrode assembly includes a positive electrode 11, a negative electrode 12, and a separator 13 interposed between the positive electrode 11 and the negative electrode 12.

The negative electrode 12 includes a negative electrode current collector 12a and a negative electrode active material layer 12b carried on one face thereof. Likewise, the positive electrode 11 includes a positive electrode current collector 11a and a positive electrode active material layer 11b carried on one face thereof.

One end of a negative electrode lead 16 is connected to the face of the negative electrode current collector 12a on which the negative electrode active material layer 12b is not formed. One end of a positive electrode lead 15 is connected to the face of the positive electrode current collector 11a on which the positive electrode active material layer 11b is not formed.

The battery case 14 has openings at opposite positions. From one of the openings of the battery case 14, the other end of the positive electrode lead 15 is drawn to outside. From the other opening of the battery case 14, the other end of the negative electrode lead 16 is drawn to outside. Each opening of the battery case 14 is sealed with a sealant 17.

In the invention, the negative electrode active material layer 12b has a first portion 18 including a material capable of absorbing and desorbing lithium ions, which serves as the negative electrode active material, and a second portion 19 covering at least a part of a surface of the first portion 18. The second portion 19 includes at least one material that is less reactive with oxygen than the material included in the first portion 18.

The first portion 18 including a material capable of absorbing and desorbing lithium ions (for example, Si containing material) is highly reactive with oxygen. Thus, by covering at least a part of the surface of the first portion 18 with the second portion 19 including at least one material that is less reactive with oxygen than the first portion 18, the contact between the first portion 18 and oxygen can be suppressed. Hence, the oxidation of the first portion 18 is suppressed, and heat generation due to oxidation can also be suppressed. This permits a further improvement in the safety of the lithium secondary battery.

It is preferable that the first portion 18 include a Si containing material, since a high battery capacity can be obtained. Examples of Si containing materials include silicon (simple substance), silicon oxides B, silicon nitrides, silicon containing alloys, and silicon containing compounds.

The silicon oxides B are preferably represented by the general formula (1):

SiO_{y} where 0≦y≦0.8 (1)

The molar ratio y of oxygen to silicon is more preferably 0.1≦21 y≦0.7.

The silicon nitrides are preferably represented by the general formula (2):

SiNₐ where 0<a<4/3 (2)

The molar ratio a of nitrogen to silicon is more preferably 0.01≦a≦1.

The silicon containing alloys contain silicon and other metal element M than silicon. The metal element M is desirably a metal element not alloyable with lithium. The metal element M can be any electronic conductor that is chemically stable, and is desirably at least one selected from the group consisting of, for example, titanium (Ti), copper (Cu), and nickel (Ni). One metal element M may be singly contained in the silicon containing alloy, or two or more metal elements M may be contained in the silicon containing alloy. The molar ratio of the metal element M to silicon in the silicon containing alloy is preferably in the following range.

When the metal element M is Ti, preferably 0<Ti/Si<2, and more preferably 0.1≦Ti/Si≦1.0.

When the metal element M is Cu, preferably 0<Cu/Si<4, and more preferably 0.1≦Cu/Si≦2.0.

When the metal element M is Ni, preferably 0<Ni/Si<2, and more preferably 0.1≦Ni/Si≦1.0.

The silicon containing compounds include compounds other than silicon (simple substance), the silicon oxides B, the silicon nitrides, and the silicon containing alloys.

Among them, preferable Si containing materials are, for example, silicon (simple substance), silicon oxides B, silicon nitrides, and silicon containing alloys.

The first portion 18 may include these materials singly or in combination of two or more.

The second portion 19 includes a material that is less reactive with oxygen than the first portion 18.

For example, when the first portion is composed of silicon (simple substance) or SiO_{y} where 0≦y≦0.8, the second portion can be composed of, for example, a material whose standard Gibbs energies of formation of oxides in an Ellingham diagram are larger than silicon (simple substance) or Si oxides. Examples of such materials include metallic tin, metallic nickel, metallic cobalt, and carbon (simple substance). It is also possible to use silicon oxides A represented by SiOₓ where 1.0≦x≦2, since they are less reactive with oxygen than silicon (simple substance) or SiO_{y} where 0≦y≦0.8. The molar ratio x of oxygen to silicon in the silicon oxides A is more preferably 1.2≦x≦1.95. It is also possible to use tin oxides as the material of the second portion. The tin oxides are preferably represented by SnO_{z} where 1.0≦z≦2.

When the first portion 18 is composed of a silicon nitride and/or a silicon containing alloy, the second portion 19 can also be formed of, for example, metallic tin, metallic nickel, metallic cobalt, or carbon (simple substance). This also holds true when the first portion 18 is composed of a silicon containing compound.

The second portion 19 may cover a part of the surface of the first portion 18 or may cover the whole surface of the first portion 18. It is preferable, however, that the second portion 19 cover the whole surface of the first portion 18, since the reaction between the first portion 18 and oxygen can be further suppressed.

The thickness of the second portion 19 covering the surface of the first portion 18 is preferably 0.1 to 5 μm, and more preferably 0.3 to 3 μm. If the thickness of the second portion 19 is less than 0.1 μm, it is difficult to cover a large area of the first portion 18. As a result, the reaction between the first portion 18 and oxygen may not be suppressed sufficiently. If the thickness of the second portion 19 is greater than 5 μm, the energy density may become low, or the second portion 19 may separate since it cannot accommodate the expansion and contraction of the first portion 18 due to charge/discharge.

The thickness of the second portion 19 is defined as the average width between the surface of the second portion 19 and the face of the second portion 19 in contact with the first portion 18 in the thickness direction thereof. The thickness of the second portion 19 can be obtained by observing the width with an electron microscope, for example, at 2 to 10 locations in a longitudinal cross-section of the active material layer 12b, and averaging the obtained values.

The coverage rate of the surface of the first portion 18 with the second portion 19 is preferably 50% or more, and more preferably 60% or more. If the coverage rate is less than 50%, the reaction between oxygen and the first portion 19 mainly serving as the active material may not be sufficiently suppressed.

As used herein, the coverage rate refers to the ratio of the part of the first portion 18 covered with the second portion 19 to the whole surface of the first portion 18. For example, in the case of the negative electrode active material layer 12b of FIG. 1, the surface of the first portion 18 includes the side faces of the first portion 18 as well as the face of the first portion 18 facing the positive electrode active material layer with the separator therebetween.

For example, when the negative electrode active material layer 12b is in the form of a thin film having a uniform or almost uniform thickness, the coverage rate can be obtained as the ratio of the length of the part of the first portion 18 in contact with the second portion 19 to the length of the perimeter (the length of the outside edge) of the first portion 18 excluding the part in contact with the current collector in a longitudinal cross-section of the negative electrode active material layer 12b. The longitudinal cross-section used to obtain the coverage rate may be any longitudinal cross-section of the negative electrode active material layer 12b. In this case, the coverage rate can be determined, for example, by obtaining the above-described ratio in predetermined 2 to 10 longitudinal cross-sections and averaging the obtained values.

When the negative electrode active material layer 12b has an uneven shape, for example, when the negative electrode active material layer 12b is composed of a plurality of columnar particles which will be described below, the coverage rate can be obtained as the ratio of the length of the part of the first portion 18 in contact with the second portion 19 to the length of the perimeter (the length of the outside edge) of the first portion 18 excluding the part in contact with the current collector in a longitudinal cross-section including the highest position of the active material layer from the surface of the current collector. For example, when the active material layer is composed of a plurality of columnar particles carried on protrusions of a current collector, the aforementioned longitudinal cross-section includes the highest point of the active material layer from the surface of the protrusions. The coverage rate can be determined, for example, by obtaining the aforementioned ratios of 2 to 10 columnar particles and averaging the obtained values.

The length of the perimeter (the length of the outside edge) of the first portion 18 excluding the part in contact with the current collector in a predetermined longitudinal cross-section can be measured even when the second portion is carried on the surface of the first portion. The first portion and the second portion can be distinguished according to composition analysis using electron microscope observation, an electron beam microanalyzer (EPMA) or the like. For example, a first portion comprising a silicon oxide B is covered with a second portion comprising a silicon oxide A, the first portion and the second portion can be distinguished by such composition analysis.

When the second portion 19 covers the whole surface of the first portion 18, it is preferable that the second portion 19 have lithium ion conductivity (i.e., the second portion 19 be capable of absorbing or desorbing lithium ions). An example of materials having such lithium ion conductivity is metallic tin. However, metallic nickel or the like has low lithium ion conductivity. Thus, when the second portion 19 is composed of metallic nickel or the like, it is preferable that the second portion 19 partially cover the surface of the first portion 18.

The second portion 19 may include two or more materials that are less reactive with oxygen than the first portion 18. For example, the second portion 19 can be composed of a first layer having a high lithium ion conductivity and a second layer having a lower lithium ion conductivity than the first layer. The second portion 19 can include, for example, a first layer comprising metallic tin, and at least one second layer selected from the group consisting of a metallic nickel layer and a metallic cobalt layer. The first layer and the second layer of the second portion 19 are preferably arranged so that the first layer is in contact with the first portion and that the second layer is carried on the first layer. In this case, the first layer preferably covers the whole surface of the first portion 18, and the second layer preferably covers only a part of the surface of the first layer. By using such a second portion 19, the contact between the first portion 18 and oxygen can be further suppressed.

In this case, it is also preferable that the thickness of the second portion be 0.1 to 5 μm.

The use of a film-shaped negative electrode active material layer as illustrated in FIG. 1 is also advantageous in that the first portion can be easily covered with the second portion at a high coverage rate.

The thickness of the negative electrode active material layer 12b is preferably 3 to 100 μm. If the thickness of the negative electrode active material layer 12b is less than 3 μm, the capacity per unit area becomes low, which may result in a small energy density of the battery. If the thickness of the negative electrode active material layer 12b is greater than 100 μm, the amount of expansion and contraction of the first portion 18 due to charge/discharge becomes large, so that the second portion 19 may separate or the first portion 18 may separate from the current collector. A negative electrode in another embodiment will be described below, and it is also preferable that the thickness of the negative electrode active material layer of this negative electrode be in the aforementioned range.

As used herein, the thickness of the negative electrode active material layer 12b refers to the distance between the surface of the negative electrode active material layer 12b and the upper face of the negative electrode current collector 12a in contact with the negative electrode active material layer 12b in the direction of the normal to the surface of the negative electrode current collector 12a. The thickness of the negative electrode active material layer 12b can be determined, for example, by measuring the aforementioned distance at any 2 to 10 locations (or, in any 2 to 10 columnar particles) in a longitudinal cross-section of the negative electrode active material layer 12b, and averaging the measured values.

When the negative electrode active material layer 12b is composed of a plurality of columnar particles, the thickness of the negative electrode active material layer 12b refers to the distance between the highest position of the columnar particles and the upper face of the protrusions of the current collector in contact with the columnar particles in the direction of the normal to the surface of the negative electrode current collector 12a.

The thickness (height) of the first portion is determined as appropriate, depending on battery capacity, etc.

In the negative electrode 12 illustrated in FIG. 1, the material of the negative electrode current collector 12a is not particularly limited. An exemplary material is copper. Also, the thickness of the negative electrode current collector 12a is not particularly limited, but it is usually 5 to 500 μm, and preferably 5 to 50 μm.

The negative electrode active material layer 12b including the first portion 18 and the second portion 19 illustrated in FIG. 1 can be prepared, for example, by forming the first portion 18 on the current collector 12a and forming the second portion 19 on the surface of the first portion 18.

For example, the negative electrode active material layer 12b of FIG. 1 can be prepared as follows. In the following description, the first portion 18 includes a silicon oxide.

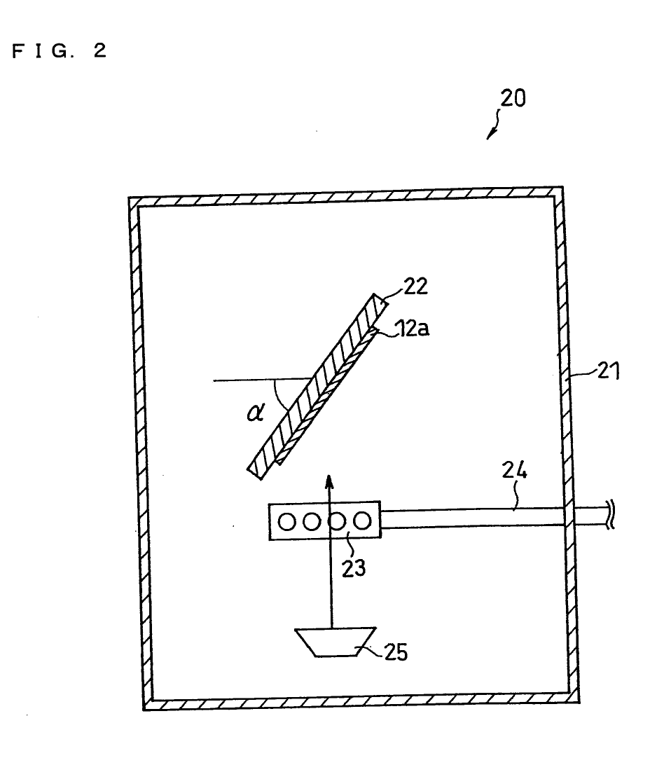

First, a layer comprising the first portion 18 is formed on the predetermined negative electrode current collector 12a. The layer comprising the first portion 18 can be prepared by using, for example, a deposition device 20 equipped with an electron beam heating means (not shown) as illustrated in FIG. 2.

The deposition device 20 of FIG. 2 includes a vacuum chamber 21, a gas pipe 24 for introducing oxygen gas into the vacuum chamber 21, and a nozzle 23. The nozzle 23 is connected to the gas pipe 24 introduced into the vacuum chamber 21. The gas pipe 24 is connected to an oxygen cylinder (not shown) via a massflow controller (not shown).

Disposed above the nozzle 23 is a fixing table 22 for fixing the negative electrode current collector 12a. Disposed vertically below the fixing table 22 is a target 25. Between the negative electrode current collector 12a and the target 25 is oxygen atmosphere comprising oxygen gas.

A silicon containing material, for example, silicon (simple substance) can be used as the target 25.

In the deposition device 20 of FIG. 2, the negative electrode current collector 12a is fixed to the fixing table 22, and the angle a formed between the fixing table 22 and a horizontal plane is set to 0°. That is, the face of the fixing table 22 to which the negative electrode current collector 12 is fixed is made horizontal.

In the case of using silicon (simple substance) as the target 25, when the target 25 is irradiated with an electron beam, silicon atoms evaporate from the target 25. The evaporated silicon atoms pass through the oxygen atmosphere and deposit, together with oxygen atoms, on the current collector. In this way, the first portion 18 comprising a silicon oxide is formed on the current collector.

The first portion 18 comprising a silicon oxide can also be formed by using a silicon oxide as the target without providing oxygen atmosphere between the current collector and the target, and depositing the silicon oxide on the current collector.

By using nitrogen atmosphere instead of the oxygen atmosphere and using silicon (simple substance) as the target, the first portion 18 comprising a silicon nitride can also be formed on the current collector 12a.

Further, for example, the first portion 18 comprising silicon (simple substance) or the first portion 18 comprising a silicon containing alloy can be formed by using the deposition device 20, evaporating silicon (simple substance) or a material (or a mixture) containing elements constituting the silicon containing alloy in a vacuum, and depositing it on the negative electrode current collector 12a.

Next, the second portion 19 is formed on the surface of the first portion 18. The second portion 19 can be formed, for example, by deposition or plating. For example, when the second portion 19 is formed by deposition, the second portion 19 can be formed by using the deposition device 20 illustrated in FIG. 2. Specifically, the second portion 19 can be formed by using a material forming the second portion 19 as the target, and depositing the material on the first portion 18.

In the case of using the deposition device 20 of FIG. 2, the thickness of the first portion 18 and the thickness of the second portion 19 can be controlled, for example, by adjusting the deposition time, etc. The coverage rate of the surface of the first portion 18 with the second portion 19 can be controlled, for example, by adjusting the power, etc. used to evaporate the material forming the second portion 19 (target). Alternatively, the coverage rate can be controlled as follows. A resist layer having a predetermined opening is formed on the first portion 18, and the second portion 19 is deposited on the resist layer, followed by removal of the resist layer. The coverage rate can also be adjusted by controlling the area of the opening of the resist layer.

In the case of using metallic tin (Sn) as the material forming the second portion 19, if the power used to evaporate the metallic tin is large, the deposited metallic tin may remelt and become spherical, thereby resulting in a low coverage rate. In the case of using metallic tin, it is thus preferable to adjust the coverage rate by adjusting the power for deposition.

The second portion 19 can also be formed by plating. Specifically, the second portion 19 can be formed on the surface of the first portion 18 by using the current collector with the first portion 18 formed thereon as the cathode, immersing the current collector in a liquid electrolyte containing ions of the metal forming the second portion 19, and passing a current between the cathode and a predetermined anode.

In this method, the thickness of the second portion 19 can be controlled, for example, by adjusting the current passage time etc. For example, when a second portion is plated on a first portion with a resist layer, having a predetermined opening, formed on the surface, the coverage rate of the surface of the first portion 18 with the second portion 19 can be controlled by adjusting the area of the opening of the resist layer.

Alternatively, the second portion 19 can also be formed by applying a paste containing the material forming the second portion 19 on the surface of the first portion 18 and sintering the applied film.

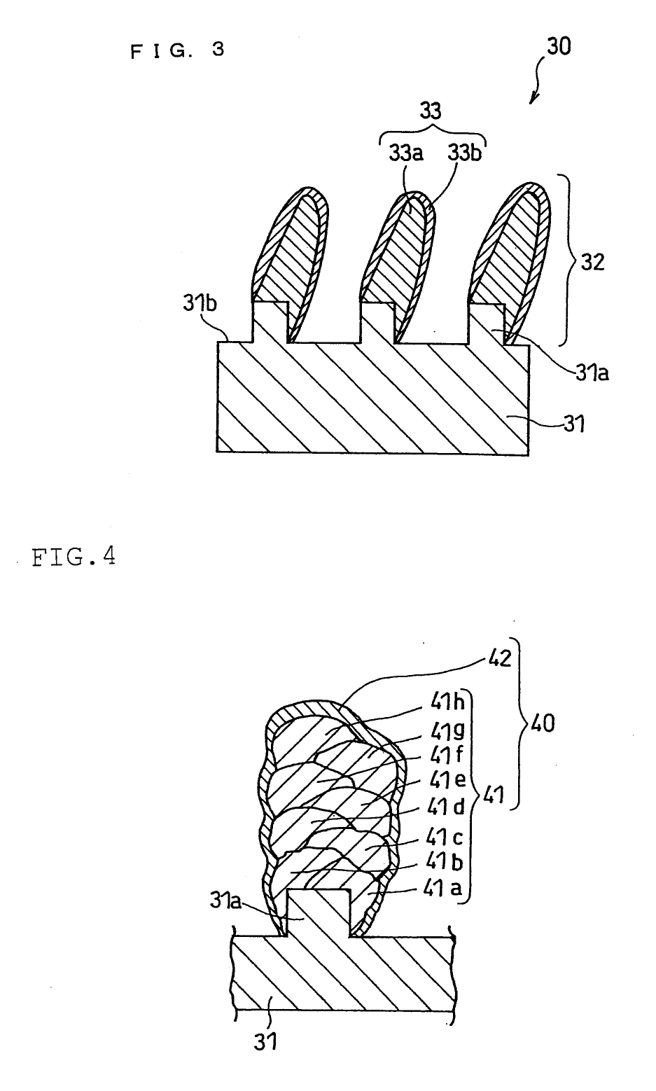

The negative electrode active material layer may be composed of a plurality of columnar particles. FIG. 3 schematically shows a negative electrode 30 included in a lithium secondary battery according to another embodiment of the invention.

The negative electrode 30 of FIG. 3 includes a negative electrode current collector 31 and a negative electrode active material layer 32 carried thereon. The negative electrode active material layer 32 includes a plurality of columnar active material particles 33. Each of the columnar active material particles 33 includes a columnar first portion 33a and a second portion 33b covering the surface of the first portion 33a. The grow direction of the active material particles 33 is slanted relative to the direction of the normal to the surface of the current collector. It should be noted that the direction of the normal to the surface of the current collector is uniquely defined even when the surface of the current collector is provided with protrusions, since it is flat by visual inspection.

The negative electrode current collector 31 has a plurality of protrusions 31a on one or both faces thereof in the thickness direction. The protrusions 31a extend outwardly from a surface 31b of the negative electrode current collector 31 in the thickness direction (hereinafter referred to as simply “surface 31b”). The columnar active material particles 33 are carried on the protrusions 31a.

The current collector 31 having the protrusions 31a on the surface(s) can be produced, for example, by utilizing techniques of forming protrusions and depressions on a current collector comprising metal foil, sheet metal, etc. Examples of such techniques include a method using a roller having depressions on the surface (hereinafter “roller method”) and a photoresist method.

According to the roller method, the protrusions 31a can be formed on at least one face of a current collector by mechanically pressing the current collector using a roller having depressions on the surface (hereinafter “protrusion-forming roller”).

For example, two protrusion-forming rollers are pressed against each other in such a manner that their axes are parallel, and a current collector sheet is passed and pressed between the two rollers. In this way, a current collector having protrusions on both surfaces in the thickness direction can be obtained. Also, a protrusion-forming roller and a roller having a flat surface are pressed against each other in such a manner that their axes are parallel, and a current collector is passed and pressed between the two rollers. In this way, a current collector having protrusions on one surface in the thickness direction can be obtained. The roller having a flat surface is preferably such that at least the surface is made of an elastic material. The pressure applied to the rollers is selected as appropriate, depending on the material and thickness of the current collector, the shape and dimensions of the protrusions 31a, the set value of thickness of the current collector obtained by pressing, etc.

According to the photoresist method, a negative electrode current collector having protrusions on a surface can be produced by forming a resist pattern on a surface of a predetermined metal sheet, and applying a metal plating thereto.

The surfaces of the protrusions 31a may have micro-protrusions. The protrusions 31a having micro-protrusions can be formed, for example, as follows. First, protrusions larger than the design dimensions of the protrusions 31a are formed by the photoresist method. By etching the protrusions, the protrusions 31a having micro-protrusions on the surface are formed. The protrusions 31a having micro-protrusions on the surface can also be formed by plating the surface of the protrusions 31a.

The height of the protrusions 31a is not particularly limited, but the average height is preferably approximately 3 to 10 μm. In this specification, the height of the protrusion 31a is defined in a cross-section of the protrusion 31a in the thickness direction of the current collector 31. As used herein, “a cross-section of the protrusion 31a” refers to a cross-section including the furthest point in the direction in which the protrusion 31a extends. In such a cross-section of the protrusion 31a, the height of the protrusion 31a is the length of a perpendicular line between the furthest point in the extending direction of the protrusion 31a and the surface 31b. The average height of the protrusions 31a can be determined, for example, by observing a cross-section of the current collector 31 in the thickness direction of the current collector 31 with a scanning electron microscope (SEM), measuring the heights of, for example, 100 protrusions 31a, and calculating the average value from the measured values.

The cross-sectional diameter of the protrusions 31a is also not particularly limited, but it is, for example, 1 to 50 μm. The cross-sectional diameter of the protrusion 31a is the largest width of the protrusion 31a parallel to the surface 31b in the cross-section of the protrusion 31a that is used to determine the height of the protrusion 31a. The cross-sectional diameter of the protrusions 31a can also be determined by measuring the largest widths of 100 protrusions 31a and calculating the average value from the measured values in the same manner as the height of the protrusions 31a.

It should be noted that all the protrusions 31a do not have to have the same height or the same cross-sectional diameter.

The shape of the protrusions 31a seen from the direction of the normal to the surface of the current collector is not particularly limited. The shape can be, for example, a circle, polygon, oval, parallelogram, trapezoid, or rhombus. In consideration of production costs etc., the polygon is preferably a triangle to an octagon, and more preferably a regular triangle to a regular octagon.

Each of the protrusions 31a has an almost flat top face at the end in the extending direction. When the end of the protrusion 31a has a flat top face, the adhesion between the protrusion 31a and the columnar active material particle 33 is enhanced. In terms of enhancing the strength of adhesion, it is more preferable that the flat face at the end be almost parallel to the surface 31b.

The number of the protrusions 31a, the interval between the protrusions 31a and the like are not particularly limited and can be selected as appropriate, depending on, for example, the size (e.g., height and cross-sectional diameter) of the protrusions 31a and the size of the first portions 33a formed on the surfaces of the protrusions 31a. The number of the protrusions 31a is, for example, approximately 10,000 to 10,000,000/cm². Also, the protrusions 31a are preferably formed so that the center-to-center distance of the adjacent protrusions 31a is approximately 2 to 100 μm.

As mentioned above, each of the protrusions 31a may have a micro-protrusion (not shown) on the surface. In this case, for example, the adhesion between the protrusion 31a and the active material particle 33 is further enhanced, so that separation of the active material particle 33 from the protrusion 31a, expansion of such separation, etc. are prevented in a more reliable manner. The micro-protrusion is provided so as to extend outwardly from the surface of the protrusion 31a. The surface of the protrusion 31a may have two or more micro-protrusions smaller than the protrusion 31a. The micro-protrusion(s) may be formed on a side face of the protrusion 31a so as to extend in the circumferential direction and/or grow direction of the protrusion 31a. Also, when the protrusion 31a has a flat top face at the end, the top face may have one or more micro-protrusions smaller than the protrusion 31a. Further, the top face may have one or more micro-protrusions that extend in one direction.

In the case of the negative electrode 30 of FIG. 3, each of the columnar active material particles 33 also has a columnar first portion 33a and a second portion 33b covering the surface of the first portion 33a. Due to the provision of the second portion 33b, the reaction between the first portion 33a and oxygen is sufficiently suppressed, and the heat generation of the negative electrode 30 can be reduced. It is thus possible to further improve the safety of the lithium secondary battery.

In the negative electrode 30 of FIG. 3, it is also preferable that the coverage rate of the surface of the first portion 33a with the second portion 33b and the thickness of the second portion 33b be in the above-described ranges.

The second portion 33b may cover a part of the surface of the first portion 33a or may cover the whole surface of the first portion 33a.

Also, the thickness of the active material layer 32 including the columnar active material particles 33 illustrated in FIG. 3 is preferably 3 to 100 μm in the same manner as described above.

Further, in the negative electrode 30 of FIG. 3, the columnar active material particles 33 are arranged with a space between the adjacent active material particles 33, so that they are spaced apart from one another. Such an arrangement eases the stress exerted by the expansion and contraction due to charge/discharge, thereby making separation of the negative electrode active material layer 32 from the current collector 31 and deformation of the negative electrode current collector 31 and the negative electrode 30 unlikely to occur.

In the same manner as described above, the second portion 33b may include a first layer comprising metallic tin and at least one second layer selected from the group consisting of a metallic nickel layer and a metallic cobalt layer.

The diameter of the columnar first portion 33a depends on the size of the protrusion. In terms of preventing the first portion 33a from becoming cracked or separated from the current collector due to the expansion upon charge, the diameter of the columnar first portion 33a is preferably 100 μm or less, and more preferably 1 to 50 μm. As used herein, the diameter of the first portion 33a refers to the particle size at the center height of the first portion 33a in the direction perpendicular to the grow direction of the first portion 33a. The center height as used herein refers to the height of the midpoint between the highest position of the first portion 33a in the direction of the normal to the current collector 31 and the upper face of the protrusion 31a in contact with the first portion 33a. The diameter of the first portion 33a can be obtained, for example, by selecting any 2 to 10 columnar particles, measuring their particle sizes at the center height in the direction perpendicular to the grow direction, and averaging the measured values.

The columnar first portions 33a of the negative electrode 30 of FIG. 3 can be formed, for example, by using the current collector 31 having the protrusions 31a on the surface and the deposition device 20 as illustrated in FIG. 2.

The current collector 31 having the protrusions 31a on the surface is fixed to the fixing table 22. The fixing table 22 is slanted so that the fixing table 22 and a horizontal plane form an angle α. A material forming the first portion 33a is used as the target 25, and the material is deposited on the current collector 31. At this time, the material is concentrated and deposited on the protrusions 31a on the current collector surface, so that the first portions 33a are formed on the protrusions 31a.

In the same manner as described above, for example, the height of the columnar first portions 33a is determined as appropriate, depending on battery capacity, etc. As used herein, the height of the columnar first portion 33a refers to the distance between the highest position of the columnar first portion 33a and the upper face of the protrusion 31a in the direction of the normal to the surface of the current collector 31. The height of the columnar first portion 33a can be determined by selecting, for example, 2 to 10 columnar first portions 33a, obtaining their heights, and averaging the obtained values.

The second portion 33b covering the surface of the first portion 33a can be formed, for example, by deposition, plating, etc.

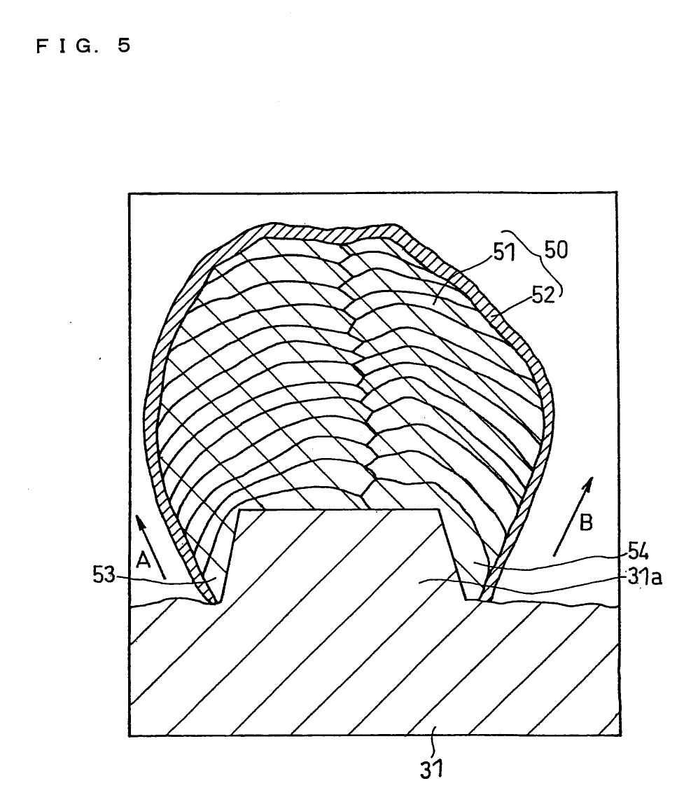

When the first portion 33a is in the form of a columnar particle, the first portion 33a may be composed of a single particle as illustrated in FIG. 3, or may be composed of a laminate of a plurality of grain layers as illustrated in FIGS. 4 and 5. Also, the grow direction of the columnar particles may be slanted relative to the direction of the normal to the surface of the current collector, as illustrated in FIG. 3. Alternatively, the average grow direction of the whole columnar particles may be parallel to the direction of the normal to the surface of the current collector, as illustrated in FIGS. 4 and 5. In the negative electrodes of FIGS. 4 and 5, it is also preferable that the coverage rate of the surface of the first portion with the second portion, the thickness of the second portion, the thickness of the active material layer, etc. be in the aforementioned ranges. Also, the second portion may include two or more materials that are less reactive with oxygen than the first portion.

FIG. 4 illustrates a columnar active material particle 40 included in a negative electrode of a lithium secondary battery according to still another embodiment of the invention. FIG. 5 illustrates a columnar active material particle 50 included in a negative electrode of a lithium secondary battery according to still another embodiment of the invention. In FIGS. 4 and 5, the same constituent components as those of FIG. 3 are given the same numbers, and their descriptions are omitted.

The columnar active material particle 40 of FIG. 4 is carried on the protrusion 31a of the current collector 31. The columnar negative electrode active material particle 40 includes a columnar first portion 41 and a second portion 42 covering the surface of the first portion 41.

The columnar first portion 41 is composed of a laminate including eight grain layers 41a, 41b, 41c, 41d, 41e, 41f, 41g, and 41h. In the columnar first portion 41, the grow direction of the grain layer 41a is slanted in a predetermined first direction relative to the direction of the normal to the surface of the current collector. The grow direction of the grain layer 41b is slanted in a second direction different from the first direction relative to the direction of the normal to the surface of the current collector. Likewise, the grain layers included in the columnar first portion 41 are slanted alternately in the first direction and the second direction relative to the direction of the normal to the surface of the current collector. In this way, by laminating a plurality of grain layers in such a manner that the grow directions of the grain layers are changed alternately in the first direction and the second direction, the average grow direction of the whole columnar particle constituting the first portion can be made parallel to the direction of the normal to the surface of the current collector.

Alternatively, if the grow direction of the whole columnar particle is parallel to the direction of the normal to the surface of the current collector, the grow directions of the respective grain layers may be slanted in different directions.

The columnar first portion 41 illustrated in FIG. 4 can be formed, for example, as follows. First, the grain layer 41a is formed so as to cover the top face of the protrusion 31a of the current collector 31 and a part of the adjacent side face thereof. Next, the grain layer 41b is formed so as to cover the remaining part of the side face of the protrusion 31a and a part of the top face of the grain layer 41a. That is, in FIG. 4, the grain layer 41a is formed at one end of the protrusion 31a so as to include the top face thereof, whereas the grain layer 41b is formed at the other end of the protrusion 31a although it partially overlaps the grain layer 41a. Further, the grain layer 41c is formed so as to cover the remaining part of the top face of the grain layer 41a and a part of the top face of the grain layer 41b. That is, the grain layer 41c is formed so as to mainly contact the grain layer 41a. Further, the grain layer 41d is formed so as to mainly contact the grain layer 41b. Likewise, by alternately laminating the grain layers 41e, 41f, 41g, and 41h, the columnar first portion as illustrated in FIG. 4 is formed.

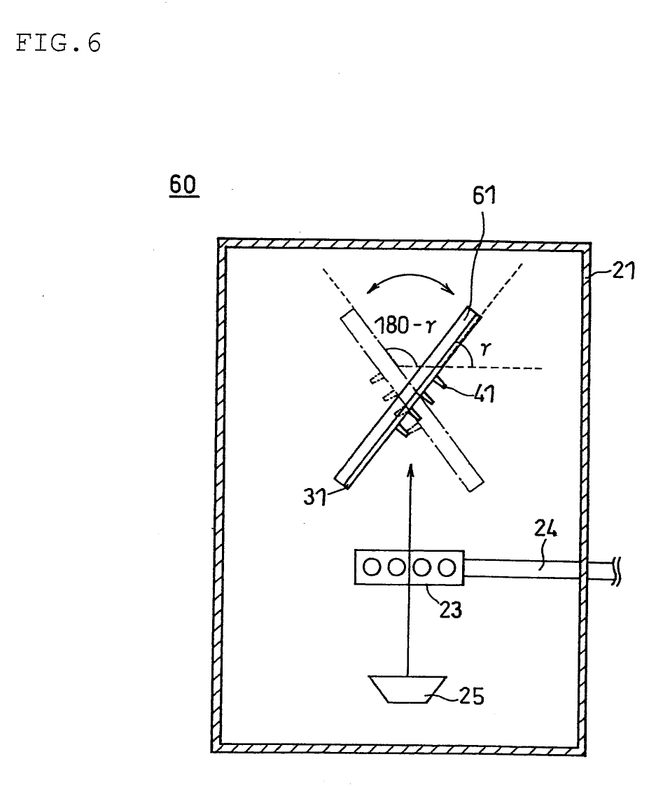

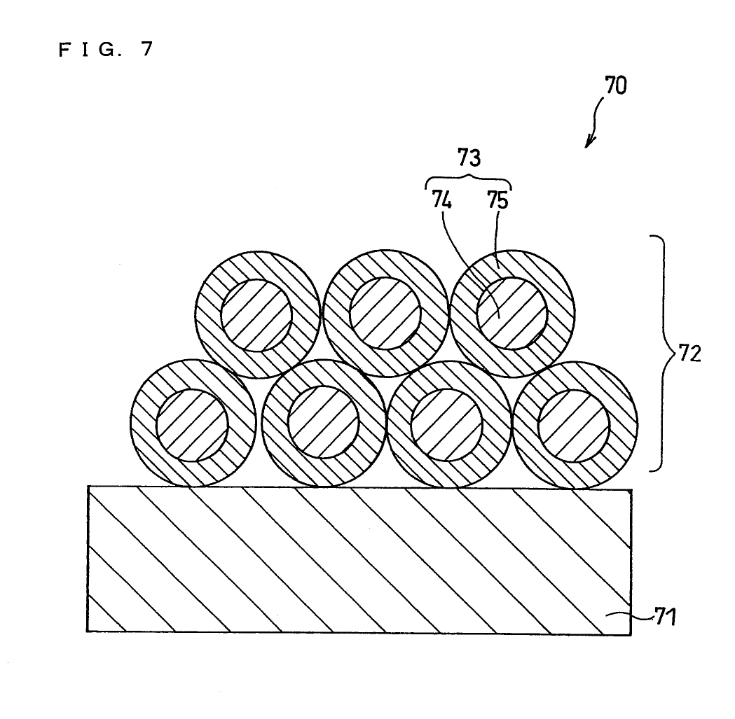

The columnar first portion 41 of FIG. 4 can be formed by using, for example, a deposition device 60 as illustrated in FIG. 6. FIG. 6 is a side view schematically showing the structure of the deposition device 60. In FIG. 6, the same constituent components as those of FIG. 2 are given the same numbers, and their descriptions are omitted. In the following description, the first portion is also composed of a silicon oxide.

A fixing table 61 is shaped like a plate and is rotatably supported in the vacuum chamber 21. The current collector 31 having the protrusions on the surface is fixed to one face of the fixing table 61 in the thickness direction thereof. The fixing table 61 is rotated between the position shown by the solid line and the position shown by the dashed line in FIG. 6. When the fixing table 61 is at the position shown by the solid line (position A), the face of the fixing table 61 to which the current collector 31 is fixed faces the target 25 positioned vertically below the fixing table 61, with the angle between the fixing table 61 and a horizontal straight line being γ°. When the fixing table 61 is at the position shown by the dashed line (position B), the face of the fixing table 61 to which the current collector 31 is fixed faces the target 25 positioned vertically below the fixing table 61, with the angle between the fixing table 61 and a horizontal straight line being (180γy)°. The angle γ° can be selected as appropriate, depending on the dimensions of the desired active material layer, etc.

In the production method using the deposition device 60, first, the current collector 31 having the protrusions 31a on the surface is fixed to the fixing table 61, and oxygen gas is introduced into the vacuum chamber 21. Subsequently, the target 25 is irradiated with an electron beam, so that it is heated and vaporized. For example, when silicon (simple substance) is used as the target, the vaporized silicon passes through the oxygen atmosphere, and a silicon oxide deposits on the surface of the current collector. At this time, by disposing the fixing table 61 at the position shown by the solid line, the grain layer 41a illustrated in FIG. 4 is formed on the protrusion 31a. Next, by rotating the fixing table 61 to the position shown by the dashed line, the grain layer 41b illustrated in FIG. 4 is formed. In this way, by alternately rotating the fixing table 61 between the position A and the position B, the first portion 41 comprising a laminate of eight grain layers illustrated in FIG. 4 is formed.

The columnar negative electrode active material particle 50 illustrated in FIG. 5 has a columnar first portion 51 and a second portion 52 covering the surface of the first portion. The columnar first portion 51 has a plurality of first grain layers 53 and a plurality of second grain layers 54.

The thickness of each grain layer included in the first portion 51 of FIG. 5 is less than that of each grain layer included in the first portion 41 of FIG. 4. Also, the contour of the first portion 51 of FIG. 5 is more smooth than that of the first portion 41 of FIG. 4.

In the columnar first portion 51 of FIG. 5, also, if the average grow direction of the whole first portion is parallel to the direction of the normal to the surface of the current collector, the grow directions of the respective grain layers may be slanted relative to the direction of the normal to the surface of the current collector. In the first portion 51 of FIG. 5, the grow direction of the first grain layers 53 is the direction A, and the grow direction of the second grain layers 54 is the direction B.

The columnar first portion 51 of FIG. 5 can be basically formed using the deposition device of FIG. 6 in the same manner as the columnar first portion 41 of FIG. 4. The first portion 51 of FIG. 5 can be produced, for example, by making the deposition time at the position A and the position B shorter than that for the first portion 41 of FIG. 4 and increasing the number of the grain layers laminated.

In each of the above-described production methods, by regularly disposing protrusions on the surface of a current collector and forming an active material layer comprising a plurality of silicon containing columnar particles on the current collector, gaps can be provided among the columnar particles at certain intervals.

In particular, a combination of a first portion comprising columnar particles of SiO_{y} where 0≦y≦0.8 and a second portion comprising a metallic tin layer is particularly preferable. By using such a high capacity silicon oxide as the first portion and using a metallic tin layer that is low in reactivity with oxygen and high in lithium ion conductivity as the second portion, it is possible to obtain a high capacity lithium secondary battery in which the reaction between the first portion and oxygen is sufficiently suppressed. That is, it is possible to obtain a high capacity lithium secondary battery with improved safety.

Also, as illustrated in FIG. 7, the negative electrode may be formed of an active material layer 72 including spherical or substantially spherical active material particles 73 and a current collector 71.

In a negative electrode 70 of FIG. 7, each of the active material particles 73 includes a spherical or substantially spherical first portion 74 and a second portion 75 covering the surface of the first portion 74.

In the active material particle 73, also, since the surface of the first portion 74 is covered with the second portion 75, the reaction between the first portion 74 and oxygen is suppressed, and the heat generation of the negative electrode 70 can be reduced. It is thus possible to further improve the safety of the lithium secondary battery.

The coverage rate of the surface of the first portion 74 with the second portion 75 and the thickness of the second portion 75 are preferably in the aforementioned ranges. The second portion 75 may cover a part of the surface of the first portion 74 or may cover the whole surface of the first portion 74. Also, the second portion 75 may include two or more materials that are less reactive with oxygen than the first portion 74.

The mean particle size of the active material particles 73 is preferably 0.1 to 30 μm. The thickness of the active material layer including the active material particles 73 is preferably 3 to 100 μm in the same manner as described above.

The negative electrode 70 of FIG. 7 can be produced, for example, as follows.

First, the spherical or substantially spherical first portions 74 are prepared, and the second portion 75 is formed on the surface of each of the first portions 74. When the second portions are composed of metal, the second portions can be formed by electroless plating. When the second portions are composed of, for example, carbon (simple substance), a silicon oxide A, or a tin oxide, the second portions can be formed by deposition.

The active material particles 73 thus produced are dispersed in a dispersion medium together with a binder and, if necessary, a conductive agent, to obtain an electrode mixture paste. The electrode mixture paste is applied onto a predetermined current collector and dried, to obtain the active material layer 72. In this way, the negative electrode 70 can be produced. After the drying, the active material layer 72 may be rolled, if necessary.

When the negative electrode 70 includes the active material layer prepared by using the electrode mixture paste containing the active material particles 73, it is preferable that the second portions 75 be composed of metal or carbon (simple substance) in order to enhance the electronic conductivity among the active material particles.

The binder and conductive agent contained in the negative electrode 70 can be any material that is known in the art.

The constituent components of the lithium secondary battery of FIG. 1 other than the negative electrode are hereinafter described.

The positive electrode 11 can include, for example, the positive electrode current collector 11a and the positive electrode active material layer 11b carried thereon. The positive electrode active material layer 11b can include a positive electrode active material and, if necessary, a binder and a conductive agent.

The positive electrode active material can be any material known in the art. Examples of such materials include lithium-containing transition metal oxides such as lithium cobaltate (LiCoO₂), lithium nickelate (LiNiO₂), and lithium manganate (LiMn₂O₄). They may be used singly or in combination of two or more of them.

Among them, the positive electrode active material preferably includes an olivine-type lithium phosphate. The olivine-type lithium phosphate decomposes at a temperature higher than the conventionally used positive electrode active materials. Thus, decomposition of the positive electrode active material resulting in production of oxygen can be suppressed. Hence, by using the above-described negative electrode active material and the positive electrode active material including an olivine-type lithium phosphate in combination, the safety of the lithium secondary battery can be significantly improved.

An example of olivine-type lithium phosphates is lithium iron phosphate (LiFePO₄).

Examples of the binder added to the positive electrode include polytetrafluoroethylene and polyvinylidene fluoride. They may be used singly or in combination of two or more of them.

Examples of the conductive agent added to the positive electrode include graphites such as natural graphite (e.g., flake graphite), artificial graphite, and expanded graphite, carbon blacks such as acetylene black, ketjen black, channel black, furnace black, lamp black, and thermal black, conductive fibers such as carbon fibers and metal fibers, metal powders such as copper and nickel, and organic conductive materials such as polyphenylene derivatives. They may be used singly or in combination of two or more of them.

The material of the positive electrode current collector 11a can be any material known in the art. Examples of such materials include Al, Al alloys, Ni, and Ti.

The non-aqueous electrolyte includes a non-aqueous solvent and a solute dissolved in the non-aqueous solvent. Examples of the non-aqueous solvent include, but are not limited to, ethylene carbonate, propylene carbonate, dimethyl carbonate, diethyl carbonate, and ethyl methyl carbonate. These non-aqueous solvents may be used singly or in combination of two or more of them.

Examples of the solute include LiPF₆, LiBF₄, LiCl₄, LiAlCl₄, LiSbF₆, LiSCN, LiCl, LiCF₃SO₃, LiCF₃CO₂, Li(CF₂SO₂)₂, LiASF₆, LiN(CF₃SO₂)₂, LiB₁₀Cl₁₀, and imides. They may be used singly or in combination of two or more of them.

The material of the separator 13 can be any material known in the art. Examples of such materials include polyethylene, polypropylene, a mixture of polyethylene and polypropylene, or copolymer of ethylene and propylene.

The shape of the lithium secondary battery of the invention is not particularly limited, and can be, for example, of the coin-type, sheet-type, or rectangular-type. Also, the lithium secondary battery can be a large-size battery for use in an electric vehicle, etc. The electrode assembly included in the lithium secondary battery of the invention may be of the layered-type as illustrated in FIG. 1 or of the wound-type.

### EXAMPLES

### Example 1

A lithium secondary battery as illustrated in FIG. 1 was produced.

### (i) Preparation of Positive Electrode

A positive electrode mixture paste was prepared by sufficiently mixing 10 g of lithium nickelate (LiNiO₂) powder with a mean particle size of 5 μm, serving as the positive electrode active material, 0.4 g of acetylene black, serving as the conductive agent, 0.3 g of polyvinylidene fluoride, serving as the binder, and a suitable amount of N-methyl-2-pyrrolidone (NMP).

The paste was applied onto one face of a 15-μm thick positive electrode current collector made of aluminum foil, dried and rolled to form a positive electrode active material layer. The positive electrode sheet thus obtained was cut to a predetermined shape to obtain a positive electrode. The positive electrode active material layer carried on one face of the current collector had a thickness of 60 μm and a size of 30 mm×30 mm. One end of an aluminum positive electrode lead was connected to the face of the positive electrode current collector having no positive electrode active material layer.

### (ii) Preparation of Negative Electrode

First, using the deposition device of FIG. 2, a first portion comprising SiO_{0.5} was formed on a negative electrode current collector. A 35-μm thick copper foil was used as the negative electrode current collector.

The negative electrode current collector was fixed to the lower face of the fixing table 22. The angle α formed between the fixing table and a horizontal plane was set to 0° Oxygen gas of purity 99.7% (available from Nippon Sanso Corporation) was sprayed from the nozzle 23 at a flow rate of 30 sccm. Silicon of purity 99.9999% (simple substance) (available from Kojundo Chemical Lab. Co., Ltd) was used as the target 25. The acceleration voltage of the electron beam applied to the target 25 was set to −8 kV, and the emission was set to 250 mA. The vapor of silicon (simple substance) passed through the oxygen atmosphere and deposited on the current collector 12a fixed to the fixing table 22.

The SiO_{0.5} layer thus obtained had a thickness of 14 μm and a size of 32 mm×32 mm.

Subsequently, a second portion comprising a metallic tin layer was formed on the SiO_{0.5} layer (first portion). The formation of the metallic tin layer was carried out by using a vacuum deposition device (SVC-700 TURBO available from Sanyu Electron Co., Ltd.).

A predetermined amount of metallic Sn was placed on a tantalum boat in the vacuum chamber of the vacuum deposition device. The current collector with the SiO_{0.5} layer was placed in the vacuum chamber so that the SiO_{0.5} layer faced the tantalum boat. The tantalum boat was heated by a power of 30 A, so that a 2-μm thick metallic tin layer was formed on the SiO_{0.5} layer. In this way, a negative electrode was produced. One end of a nickel negative electrode lead was attached to the face of the negative electrode current collector having no negative electrode active material layer.

(iii) Fabrication of Battery

A separator was disposed between the positive electrode and the negative electrode thus obtained, to obtain a layered-type electrode assembly. In the electrode assembly, the positive electrode and the negative electrode were arranged so that the positive electrode active material layer faced the negative electrode active material layer with the separator therebetween. The separator used was a 20-μm thick micro-porous film made of polyethylene (available from Asahi Kasei Corporation).

The electrode assembly thus obtained and a non-aqueous electrolyte were inserted into a battery case made of an aluminum laminate sheet. The non-aqueous electrolyte was prepared by dissolving LiPF₆ at a concentration of 1.0 mol/L in a solvent mixture of ethylene carbonate (EC) and ethyl methyl carbonate (EMC) in a volume ratio of 1:1.

The battery case was left for a predetermined time, so that the non-aqueous electrolyte was impregnated into the positive electrode active material layer, the negative electrode active material layer, and the separator. Thereafter, the other end of the positive electrode lead and the other end of the negative electrode lead were drawn to outside from the opposite openings of the battery case. In this state, while the pressure inside the battery case was reduced, the openings of the battery case were sealed with sealants. In this way, a battery was completed. This battery was designated as a battery 1A.

### Example 2

A battery of Example 2 was produced in the same manner as in Example 1, except that a second portion (surface layer) comprising carbon was formed by using a carbon deposition device (VC-100 available from Vacuum Device Inc.).

Specifically, a current collector with a SiO_{0.5} layer formed thereon was placed in the vacuum chamber of the carbon deposition device. A mechanical pencil lead with a diameter of 0.5 mm was placed so that it faced the SiO_{0.5} layer of the current collector. By passing a current until the mechanical pencil lead was burned out, a carbon layer with a thickness of approximately 30 nm was formed on the SiO_{0.5} layer. This operation was repeated 66 times, so that a carbon layer with a thickness of approximately 2 μm was formed.

### Example 3

A battery of Example 3 was produced in the same manner as in Example 1 except that a surface layer comprising SiO_{1.3} was formed. The SiO_{1.3} surface layer was formed basically in the same manner as the SiO_{0.5} layer, but the flow rate of oxygen gas from the nozzle 23 was set to 80 sccm. The acceleration voltage of the electron beam applied to the target 25 was set to −8 kV, and the emission was set to 200 mA.

### Examples 4 to 6

A negative electrode active material layer including columnar active material particles as illustrated in FIG. 3 was formed by using the deposition device illustrated in FIG. 2.

First, a negative electrode current collector having protrusions on both surfaces was prepared.

Molten chromium oxide was sprayed onto the surface of a 50-mm diameter iron roller to form a 100-μm thick ceramic layer. The surface of the ceramic layer was machined with a laser to form a plurality of circular holes (depressions) having a diameter of 12 μm and a depth of 8 μm. In this way, two protrusion-forming rollers were produced. The plurality of holes were closely packed such that the axis-to-axis distance between the adjacent holes was 20 82 m. The bottom of each hole was almost flat in the central part, and the corners formed by the ends of the bottom and the side faces of the hole were rounded.

Meanwhile, a copper alloy foil containing 0.03% by weight zirconia (available from Hitachi Cable Ltd.) was passed between the two protrusion-forming rollers pressed against each other at a linear load of 2 t/cm, so that both faces of the copper alloy foil were pressed. In this way, a negative electrode current collector having protrusions on both surfaces was obtained. A cross-section of the negative electrode current collector in the thickness direction thereof was observed with a scanning electron microscope. The average height of the protrusions was found to be approximately 8 μm.

Next, first portions comprising SiO_{0.5} were formed on the negative electrode current collector, using a deposition device (available from ULVAC, Inc.) equipped with an electron beam heating means (not shown), as illustrated in FIG. 2.

The negative electrode current collector thus obtained was cut to a predetermined size, and the cut current collector was fixed to the fixing table. The angle α formed between the fixing table and a horizontal plane was set to 60°.

The acceleration voltage of the electron beam applied to the target comprising silicon (simple substance) was set to −8 kV, and the emission was set to 250 mA. The flow rate of oxygen gas was set to 8 scmm. Under these conditions, a plurality of columnar first portions were deposited on the negative electrode current collector. The height of the first portions was 20 μm. The area of the negative electrode current collector where the columnar first portions were carried was 32 mm×32 mm.

Batteries of Examples 4 to 6 were produced in the same manner as in Examples 1 to 3, respectively, except for the use of the current collector having the above-described first portions.

### Examples 7 to 9

A current collector having first portions as illustrated in FIG. 5 was prepared in the same manner as in Example 4, except that the deposition time was made shorter than that of Example 4. Batteries of Examples 7 to 9 were produced in the same manner as in Examples 4 to 6, respectively, except for the use of the current collector having the above-described first portions.

### Examples 10 to 12

Batteries of Examples 10 to 12 were produced in the same manner as in Example 7, except that the power used to deposit metallic tin was adjusted to change the coverage rate of the surface of the first potion with the second portion comprising the metallic tin to 63% (Example 10), 54% (Example 11), or 40% (Example 12).

### Comparative Example 1

A comparative battery 1 was produced in the same manner as in Example 4 except that no second portion was provided.

### [Evaluation]

Each of the batteries thus obtained was charged to a battery voltage of 4.2 V. The charged battery was disassembled, and the positive electrode and the negative electrode were taken out. The positive and negative electrodes were cleaned with ethyl methyl carbonate (EMC).

The cleaned positive and negative electrodes were cut to 2 mm×2 mm, and laminated so that the positive electrode active material layer and the negative electrode active material layer were in contact with each other. The laminate was sealed in an SUS PAN conforming to the Fire Defense Law (cylindrical sealed container having an outer diameter of 6 mm, a height of 4 mm, and a volume of 15 μl). The PAN was then heated to 620° C. at a temperature rise rate of 10° C./min in nitrogen atmosphere to measure the endothermic/exothermic behavior with a differential scanning calorimeter. In this way, the heat generation rate (mW) in the exothermic peak resulting from the oxidation-reduction reaction between the positive and negative electrodes was obtained. Table 1 shows the results.

Table 1 also shows the composition of the first portion, the shape of the first portion, the thickness of the first portion, the material constituting the second portion, the thickness of the second portion, and the coverage rate of the surface of the first portion with the second portion after charge (coverage rate after charge).

TABLE 1

| | | | Height | | | Coverage | |
|---|---|---|---|---|---|---|---|
| | | | of | Material | Thickness | rate | Heat |
| | Composition | Shape of | first | constituting | of second | after | generation |
| | of first | first | portion | second | portion | charge | rate |
| | portion | portion | (μm) | portion | (μm) | (%) | (mW) |
| Example 1 | SiO_{0.5} | Thin | 14 | tin | 2 | 84 | 7.9 |
| | | film | | | | | |
| Example 2 | SiO_{0.5} | Thin | 14 | carbon | 2 | 75 | 12.2 |
| | | film | | | | | |
| Example 3 | SiO_{0.5} | Thin | 14 | SiO_{1.3} | 2 | 78 | 7.8 |
| | | film | | | | | |
| Example 4 | SiO_{0.5} | Columnar | 20 | tin | 2 | 68 | 12 |
| | | shape⁽¹⁾ | | | | | |
| Example 5 | SiO_{0.5} | Columnar | 20 | carbon | 2 | 63 | 10 |
| | | shape⁽¹⁾ | | | | | |
| Example 6 | SiO_{0.5} | Columnar | 20 | SiO_{1.3} | 2 | 67 | 16 |
| | | shape⁽¹⁾ | | | | | |
| Example 7 | SiO_{0.5} | Columnar | 20 | tin | 2 | 80 | 4.3 |
| | | shape⁽²⁾ | | | | | |
| Example 8 | SiO_{0.5} | Columnar | 20 | carbon | 2 | 72 | 14 |
| | | shape⁽²⁾ | | | | | |
| Example 9 | SiO_{0.5} | Columnar | 20 | SiO_{1.3} | 2 | 73 | 5.5 |
| | | shape⁽²⁾ | | | | | |
| Example 10 | SiO_{0.5} | Columnar | 20 | tin | 2 | 63 | 8.5 |
| | | shape⁽²⁾ | | | | | |
| Example 11 | SiO_{0.5} | Columnar | 20 | tin | 2 | 54 | 15 |
| | | shape⁽²⁾ | | | | | |
| Example 12 | SiO_{0.5} | Columnar | 20 | tin | 2 | 40 | 22 |
| | | shape⁽²⁾ | | | | | |
| Comparative | SiO_{0.5} | Columnar | 20 | — | — | — | 40.2 |
| Example 1 | | shape⁽¹⁾ | | | | | |

Columnar shape⁽¹⁾: The grow direction of columnar particles is slanted relative to the direction of the normal to the current collector surface.
Columnar shape⁽²⁾: The grow direction of columnar particles is almost parallel to the direction of the normal to the current collector surface.

The results of Table 1 show that when the surface of the first portion mainly serving as the negative electrode active material is covered with the second portion, the reaction between the first portion including the Si containing material and oxygen is suppressed.

Further, the results of Table 1 indicate that the coverage rate of the surface of the first portion with the second portion is preferably 50% or more.

The lithium secondary battery of the invention can be used in the same uses for conventional lithium secondary batteries. It is particularly useful as the power source for portable electronic devices, such as personal computers, cellular phones, mobile devices, personal digital assistants (PDA), portable game machines, and video cameras. It is also expected to be used, for example, as the secondary battery for assisting the electric motor in hybrid electric vehicles and fuel cell cars, the power source for power tools, vacuum cleaners, and robots, and the power source for plug-in HEVs.

Although the invention has been described in terms of the presently preferred embodiments, it is to be understood that such disclosure is not to be interpreted as limiting. Various alterations and modifications will no doubt become apparent to those skilled in the art to which the invention pertains, after having read the above disclosure. Accordingly, it is intended that the appended claims be interpreted as covering all alterations and modifications as fall within the true spirit and scope of the invention.

1. A lithium secondary battery comprising: a positive electrode including a positive electrode active material; a negative electrode including a negative electrode active material; a separator; and a non-aqueous electrolyte,
wherein the negative electrode active material comprises a first portion capable of absorbing and desorbing lithium ions and a second portion covering at least a part of a surface of the first portion, and
the second portion includes at least one material that is less reactive with oxygen than the first portion.

2. The lithium secondary battery in accordance with claim 1, wherein the first portion includes a Si containing material.

3. The lithium secondary battery in accordance with claim 1, wherein the second portion includes at least one material selected from the group consisting of metallic tin, metallic nickel, metallic cobalt, carbon simple substance, a silicon oxide A, and a tin oxide.

4. The lithium secondary battery in accordance with claim 3, wherein the second portion includes a metallic tin layer.

5. The lithium secondary battery in accordance with claim 3, wherein the second portion includes a first layer containing metallic tin and at least one second layer selected from the group consisting of a metallic nickel layer and a metallic cobalt layer, and the second layer is carried on the first layer.

6. The lithium secondary battery in accordance with claim 3, wherein the silicon oxide A is represented by SiOₓ where 1.0≦x≦2.

7. The lithium secondary battery in accordance with claim 3, wherein the tin oxide is represented by SnO_{z} where 1.0≦z≦2.

8. The lithium secondary battery in accordance with claim 1, wherein the second portion covers 50% or more of the surface of the first portion.

9. The lithium secondary battery in accordance with claim 1, wherein the second portion has a thickness of 0.1 to 5 μm.

10. The lithium secondary battery in accordance with claim 2, wherein the Si containing material includes at least one material selected from the group consisting of silicon simple substance, a silicon oxide B, a silicon nitride, a silicon containing alloy, and a silicon containing compound.

11. The lithium secondary battery in accordance with claim 10, wherein the silicon oxide B is represented by SiO_{y} where 0≦y≦0.8.

12. The lithium secondary battery in accordance with claim 1, wherein the positive electrode active material includes an olivine-type lithium phosphate.
